(19) United States
(12) Patent Application Publication
(10) Pub. No.: US 2023/0079657 A1
(43) Pub. Date: Mar. 16, 2023

(54) DYNAMICALLY CONTROLLED SENSOR DATA GENERATION PATTERN

(71) Applicant: International Business Machines Corporation, Armonk, NY (US)

(72) Inventors: Sarbajit K. Rakshit, Kolkata (IN); Siddique M. Adoni, Bangalore (IN)

(21) Appl. No.: 17/475,957

(22) Filed: Sep. 15, 2021

(51) Int. Cl. G06N 20/00; G06K 9/62

(52) U.S. Cl. CPC G06N 20/00; G06K 9/6202; G06K 9/6268

(57) ABSTRACT

A processor may receive a first set of sensor data from a plurality of sensors, the plurality of sensors having a sensor attribute associated with a first configuration. The processor may determine, utilizing an artificial intelligence model, a first classification, wherein the first classification is determined based on the first set of sensor data from the plurality of sensors. The processor may receive a second set of sensor data from the plurality of sensors, the second set of sensor data having a second configuration associated with the sensor attribute. The processor may determine a second classification. The processor may identify whether a difference between a first quality value associated with the first classification and a second quality value associated with the second classification exceeds a threshold.

### BACKGROUND

The present disclosure relates generally to the field of edge computing, and more specifically to dynamically controlling sensor data generation patterns.

In edge computing ecosystems, generated data is processed near the data collection point. In the edge computing ecosystem, there can be different types of sensors, and the sensors may be continuously gathering data.

### SUMMARY

Embodiments of the present disclosure include a method, computer program product, and system for dynamically controlling sensor data generation patterns.

A processor may receive a first set of sensor data from a plurality of sensors, the plurality of sensors having a sensor attribute associated with a first configuration. The processor may determine, utilizing an artificial intelligence model, a first classification, wherein the first classification is determined based on the first set of sensor data from the plurality of sensors. The processor may receive a second set of sensor data from the plurality of sensors, the second set of sensor data having a second configuration associated with the sensor attribute. The processor may determine a second classification. The processor may identify whether a difference between a first quality value associated with the first classification and a second quality value associated with the second classification exceeds a threshold.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for dynamically controlling sensor data generation patterns, in accordance with aspects of the present disclosure.

FIG. 2 is a flowchart of an exemplary method system for dynamically controlling sensor data generation patterns, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of edge computing, and more specifically to dynamically controlling sensor data generation patterns. While the present disclosure is not necessarily limited to such applications, various aspects of the disclosure may be appreciated through a discussion of various examples using this context.

In some embodiments, a processor may receive a first set of sensor data from a plurality of sensors, the plurality of sensors having a sensor attribute associated with a first configuration. For example, the plurality of sensors may be internet-of-things (“IoT”) sensors providing data used for edge computing. In some embodiments, the sensor attribute may be a characteristic of the sensors and/or data collected by the sensors that may have an effect on the quality, accuracy, speed, precision, or effectiveness of the collected sensor data for the purpose for which the sensor data is collected.

In some embodiments, the first configuration and the second configuration associated with the sensor attribute may be associated with at least one of a volume of data collected from the plurality of sensors, a frequency of data collected from the plurality of sensors, and a variation in types of data collected from the plurality of sensors. For example, the IoT sensors may include cameras that from time-to-time capture an image of an area for which the IoT sensors provide sensor coverage. The volume of data collected from the sensors may include any attribute of the collection or transmission of sensor data that affects the amount of data that is collected and transmitted, including, for example the pixel size of the images, the number of images taken, the number of areas in the environment of which an image is captured, etc. The frequency of data collected may include how often an image is captured (e.g., every 1 millisecond, 1 second, or 1 minute), etc. The variation in types of data collected from the plurality of sensors may include any variation in the types of data that a particular sensor is configured to be able to collect. For example, an image sensor may be able to capture black and white images, color images, IR images, thermal images, etc.

In some embodiments the processor may determine a first classification, utilizing an AI model, utilizing the first set of sensor data from the plurality of sensors. For example, the sensor data may be utilized by an AI model to classify whether a first contextual scenario is occurring. The AI model may be a classification machine learning model that is trained to identify (or classify) when any of multiple contextual scenarios are occurring. For example, the AI model may be able to classify (e.g., after being trained using historical data) road conditions from data captured by IoT sensors on, in, or in proximity to a vehicle. The AI model may be able to classify that: traffic is moving smoothly, there are high traffic volume conditions, there are low traffic volume conditions, there is an accident on the road, a request for an emergency response team needs to be made due to the accident on the road (e.g., emergency response is not present), there is poor visibility on the road, there is inclement weather in the area, etc. The AI model may be trained to identify the current contextual scenario and also determine when or how the contextual scenario changes.

In some embodiments the processor may receive a second set of sensor data from the plurality of sensors, the second set of sensor data having a second configuration for the sensor attribute. In some embodiments the processor may determine a second classification, utilizing the AI model, utilizing the second set of sensor data from the plurality of sensors. Continuing the previous example, the IoT cameras may be set to capture images every 10 seconds (the second configuration), rather than every second (the first configuration).

In some embodiments, the processor may determine whether a difference between a first quality value associated with the first classification and a second quality value associated with the second classification exceeds a threshold. The processor may compare the first classification utilizing the first set of sensor data to the second classification utilizing the second set of sensor data. The first quality value associated with the first classification may be the outcome of the classification itself (a determination that the road conditions involve high traffic volume). The second quality value associated with the first classification may be the outcome of the second classification itself (a determination that the road conditions involve high traffic volume). The difference between the first quality value associated with the first classification and the second quality value associated with the second classification may be zero if the two classifications are identical.

In some embodiments, the threshold to which the difference between the first and second quality values may be compared may be a quantification of the amount of deviance/difference between the two classifications that is acceptable or tolerable for the plurality of sensors to serve their purpose (e.g., accurately classify road conditions). For example, if first classification and the second classification are identical determinations that road conditions are involve high traffic volume, then the zero difference is below the threshold. If the first classification is that the road conditions involve moderately high traffic volume and the second classification is that the road conditions involve light traffic volume, the difference between the first classification (high traffic volume) and the second classification (low traffic volume) may be large enough that it exceeds the threshold.

In some embodiments, when the difference between the first quality value of the first classification and the second quality value of the second classification exceeds the threshold, the processor may send a command to the plurality of sensors to set the sensor attribute to the first configuration. For example, if the first classification is that the road conditions involve moderately high traffic volume and the second classification is that road conditions involve light traffic volume, the difference between the first classification (high traffic volume) and the second classification (low traffic volume) may be large enough that it exceeds the threshold. The processor may then signal to the sensors to set the sensor attribute to the first configuration (e.g., collect images of road conditions every 1 second, not every 10 seconds). The plurality of sensors may then continue to operate with the sensor attribute set to that value to collect sensor data used for classification of road conditions. In some embodiments, the command to the plurality of sensors to set the sensor attribute to the second configuration is sent automatically by a processor.

In some embodiments, when the difference between the first quality value of the first classification and the second quality value of the second classification does not exceed the threshold, the processor may send a command to the plurality of sensors to set the sensor attribute to a third configuration. In some embodiments, the processor may receive a third set of sensor data from the plurality of sensors, the plurality of sensors having the sensor attribute associated with a third configuration. In some embodiments, the processor may determine a third classification, utilizing the AI model, utilizing the third set of sensor data. For example, the IoT cameras may now be configured to capture an image every 15 seconds. The third classification, using sensor data capturing images every 15 seconds, may be that the road conditions involve low traffic volume.

In some embodiments, the processor may identify that a difference between the first quality value associated with the first classification and a third quality value associated with the third classification exceeds the threshold. For example, the processor may determine that the difference between a classification of road conditions as moderately high traffic volume and low traffic volume exceeds a threshold that demarcates acceptable variance in the classifications.

In some embodiments, the processor may send a command to the plurality of sensors to set the sensor attribute to the second configuration. In response to a determination that the third configuration for the sensor attribute results in an unacceptable classification of the contextual scenario, the processor may send a command to the plurality of sensors to utilize the second configuration (10 second intervals for capturing images to determine road conditions).

In some embodiments, the first quality value and the second quality value may be associated with an accuracy of classification. For example, the first and/or second quality values may include the actual classification itself, a quantitative assessment of the quality of the classification, the amount of data needed to arrive at the accurate classifications (collected data for 10 mins vs. collected data for 5 mins), the number of accurate classifications made (e.g., if it is a classifier that detects multiple contextual scenarios), etc. As an example, if the AI model is detecting changes in the contextual scenario, the quality value may quantitatively assess how quickly changes in contextual scenario are accurately detected.

In some embodiments, the first quality value and the second quality value may be associated with anomalies in sensor data. For example, before determining the first classification and the second classification, the sensor data used to make those classifications may be processed (or preprocessed) for use by the AI model. Anomalies may be detected during the processing stages. As an example, anomalies in the sensor data may include qualities of the sensor data that makes it not usable, qualities of the sensor data that makes it provide inaccurate classifications, qualities of the sensor data that require more sensor data to be used than normally, qualities of the sensor data that requires additional processing steps before the sensor data can be utilized by the AI model, etc.

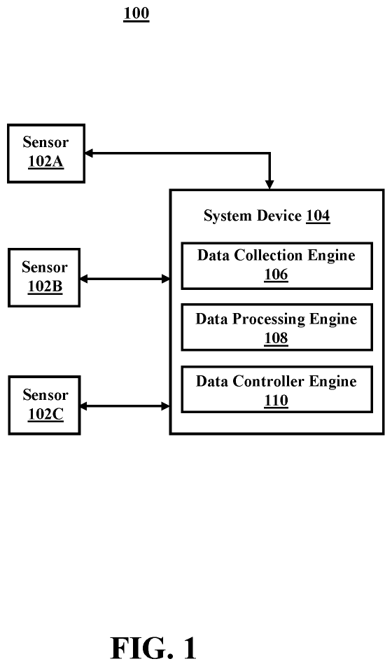

Referring now to FIG. 1, a block diagram of a system 100 for dynamically controlling sensor data generation patterns is illustrated. System 100 includes sensors 102A-C and a system device 104. The sensors 102A-C are configured to be in communication with the system device 104. The system device 104 includes a data collection engine 106, a data processing engine 108, and a data controller engine 110. In some embodiments, the system device 104 may be any device having a processor configured to perform one or more of the functions or steps described in this disclosure.

In some embodiments, sensors 102A-C obtain sensor data associated with the environment that the sensors are configured to detect. The sensors 102A-C have a sensor attribute that is initially set at a first configuration. The sensor data is sent to system device 104. The sensor data is collected by collection engine 106, and then the sensor data is sent to data processing engine 108 where the AI model of the data processing engine 108 determines a classification utilizing the first set of sensor data from sensors 102A-C. The data controller unit 110 of the system device then sends a command to the sensors 102A-C to set the sensor attribute value to a second configuration. The data collection engine 106 of the system device then receives a second set of sensors data from the sensors 102A-C, where the second set of data was collected from sensors 102A-C using the second configuration for the sensor attribute. The second set of sensor data is sent to data processing engine 108 where the AI model of the data processing engine 108 determines a second classification utilizing the second set of sensor data from sensors 102A-C. The data controller engine 110 then identifies whether a difference between a first quality value associated with the first classification and a second quality value associated with the second classification exceeds a threshold.

In some embodiments, if the difference between the first quality value of the first classification and the second quality value of the second classification exceeds the threshold, the data controller engine 110 sends a command to the sensors 102A-C to set the sensor attribute to the first configuration.

In some embodiments, if the difference between the first quality value of the first classification and the second quality value of the second classification does not exceed the threshold, the data controller engine 110 sends a command to sensors 102A-C to set the first data attribute to a third configuration. The data collection engine 106 receives a third set of sensor data from sensors 102A-C, sensors 102A-C having the sensor attribute set at a third configuration. The data processing engine 108 determines a third classification, utilizing the AI model, utilizing the third set of sensor data. The data controller engine 110 identifies that a difference between the first quality value associated with the first classification and a third quality value associated with the third classification exceeds the threshold. The data controller engine 110 sends a command to sensors 102A-C to set the sensor attribute to the second configuration.

In some embodiments, each and every sensor 102A-C is uniquely identified. The identification specifies a type of sensor for each sensor 102A-C. The data collection engine 106 may receive the data from each sensor 102A-C and classify the gathered data based on a time associated with the collection of the data and the type of sensor that is gathering data (e.g., heat sensor, motion sensor, image sensor, etc.). In some embodiments, the sensor data is used by an edge computing system for processing and analysis. A plurality of sensors 102A-C may be activated after a triggering event. The plurality of sensors 102A-C may then collect data to detect a change in the contextual scenario.

In some embodiments, the sensors 102A-C will be auto-configured and generate data for edge computing. Configuring the sensors to collect data using certain values for one or more sensor attributes may result in faster processing of data and lesser power usage for data collection and processing.

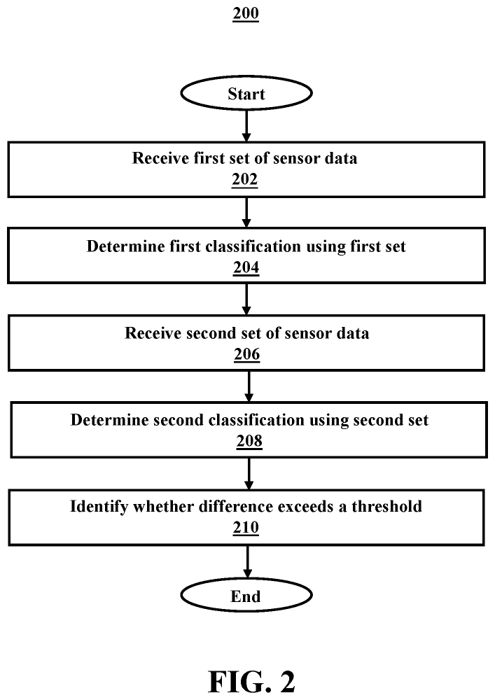

Referring now to FIG. 2, illustrated is a flowchart of an exemplary method 200 for dynamically controlling sensor data generation patterns, in accordance with embodiments of the present disclosure. In some embodiments, a processor of a system may perform the operations of the method 200. In some embodiments, method 200 begins at operation 202. At operation 202, the processor receives a first set of sensor data from a plurality of sensors, the plurality of sensors having a sensor attribute associated with a first configuration. In some embodiments, method 200 proceeds to operation 204, where the processor determines, utilizing an artificial intelligence model, a first classification, wherein the first classification is determined based on the first set of sensor data from the plurality of sensors. In some embodiments, method 200 proceeds to operation 206. At operation 206, the processor receives a second set of sensor data from the plurality of sensors, the second set of sensor data associated with a second configuration for the sensor attribute. In some embodiments, method 200 proceeds to operation 208. At operation 208, the processor determines a second classification. In some embodiments, method 200 proceeds to operation 210, where the processor determines whether a difference between a first quality value associated with the first classification and a second quality value associated with the second classification exceeds a threshold.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

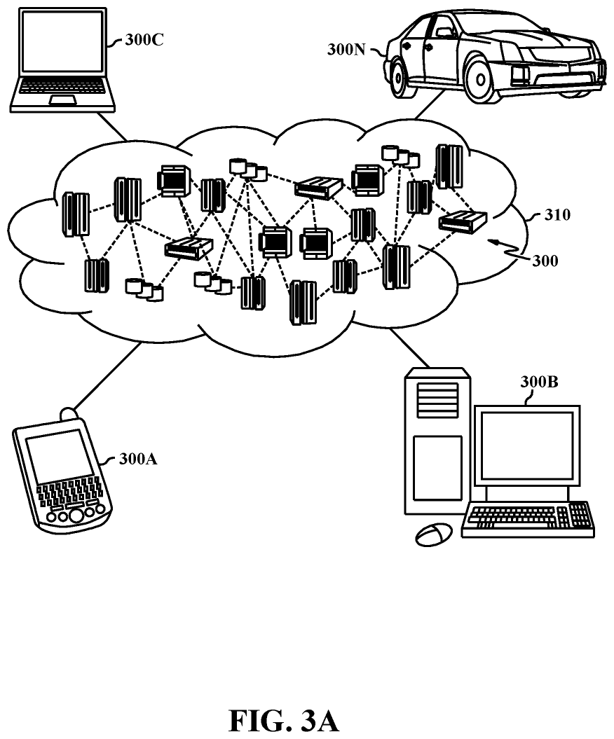

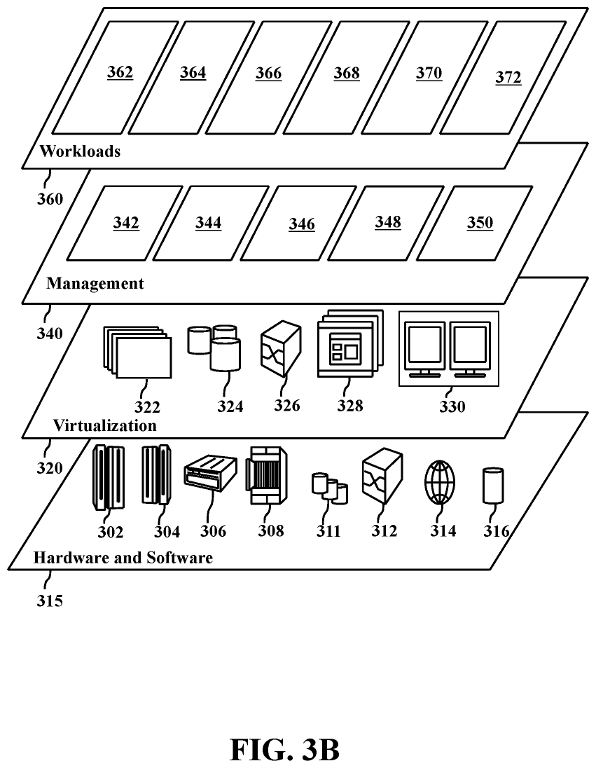

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and dynamically controlling sensor data generation patterns 372.

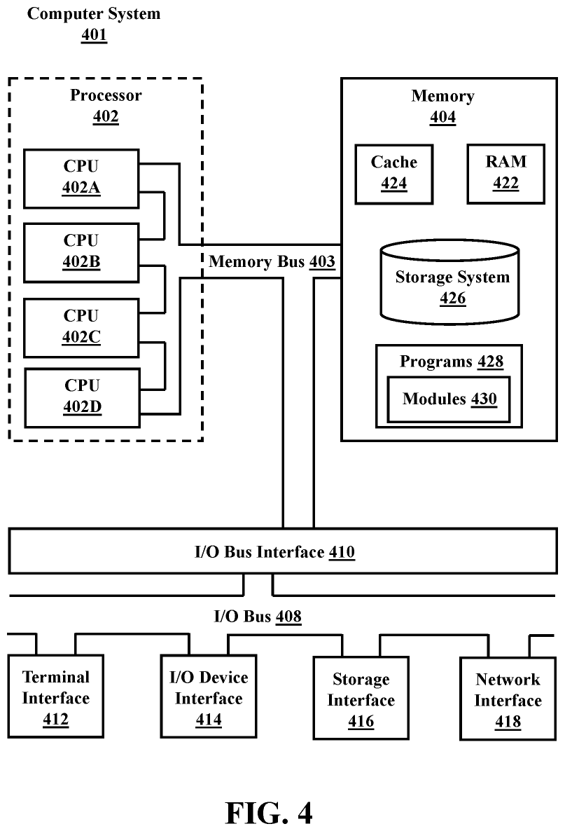

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, a first set of sensor data from a plurality of sensors, the plurality of sensors having a sensor attribute associated with a first configuration;
determining, utilizing an artificial intelligence model, a first classification, wherein the first classification is determined based on the first set of sensor data from the plurality of sensors;
receiving a second set of sensor data from the plurality of sensors, the second set of sensor data having a second configuration associated with the sensor attribute;
determining a second classification; and
determining whether a difference between a first quality value associated with the first classification and a second quality value associated with the second classification exceeds a threshold.

2. The computer-implemented method of claim 1, wherein determining whether a difference between a first quality value associated with the first classification and a second quality value associated with the second classification exceeds a threshold, includes:
identifying that the difference between a first quality value associated with the first classification and a second quality value associated with the second classification exceeds a threshold; and
sending a command to the plurality of sensors to set the sensor attribute to the first configuration.

3. The computer-implemented method of claim 1, wherein determining whether a difference between a first quality value associated with the first classification and a second quality value associated with the second classification exceeds a threshold includes:
identifying that the difference between a first quality value associated with the first classification and a second quality value associated with the second classification does not exceed a threshold;
sending a command to the plurality of sensors to set the first data attribute to a third configuration;
receiving a third set of sensor data from the plurality of sensors, the plurality of sensors having the sensor attribute having a third configuration;
determining a third classification, utilizing the artificial intelligence model, utilizing the third set of sensor data;
identifying that a difference between the first quality value associated with the first classification and a third quality value associated with the third classification exceeds the threshold; and
sending a command to the plurality of sensors to set the sensor attribute to the second configuration.

4. The computer-implemented method of claim 3, wherein the command to the plurality of sensors to set the sensor attribute to the second configuration is sent automatically by a processor.

5. The computer-implemented method of claim 1, wherein the first configuration and the second configuration associated with the sensor attribute are associated with at least one of a volume of data collected from the plurality of sensors, a frequency of data collected from the plurality of sensors, and a variation in types of data collected from the plurality of sensors.

6. The computer-implemented method of claim 1, wherein the first quality value and the second quality value are associated with an accuracy of classification.

7. The computer-implemented method of claim 1, wherein the first quality value and the second quality value are associated with anomalies in sensor data.

8. A system comprising:
a memory; and
a processor in communication with the memory, the processor being configured to perform operations comprising:
receiving a first set of sensor data from a plurality of sensors, the plurality of sensors having a sensor attribute associated with a first configuration;
determining, utilizing an artificial intelligence model, a first classification, wherein the first classification is determined based on the first set of sensor data from the plurality of sensors;
receiving a second set of sensor data from the plurality of sensors, the second set of sensor data having a second configuration associated with the sensor attribute;
determining a second classification; and
determining whether a difference between a first quality value associated with the first classification and a second quality value associated with the second classification exceeds a threshold.

9. The system of claim 8, wherein determining whether a difference between a first quality value associated with the first classification and a second quality value associated with the second classification exceeds a threshold, includes:
identifying that the difference between a first quality value associated with the first classification and a second quality value associated with the second classification exceeds a threshold; and
sending a command to the plurality of sensors to set the sensor attribute to the first configuration.

10. The system of claim 8, wherein determining whether a difference between a first quality value associated with the first classification and a second quality value associated with the second classification exceeds a threshold includes:
identifying that the difference between a first quality value associated with the first classification and a second quality value associated with the second classification does not exceed a threshold;
sending a command to the plurality of sensors to set the first data attribute to a third configuration;
receiving a third set of sensor data from the plurality of sensors, the plurality of sensors having the sensor attribute having a third configuration;
determining a third classification, utilizing the artificial intelligence model, utilizing the third set of sensor data;
identifying that a difference between the first quality value associated with the first classification and a third quality value associated with the third classification exceeds the threshold; and
sending a command to the plurality of sensors to set the sensor attribute to the second configuration.

11. The system of claim 10, wherein the command to the plurality of sensors to set the sensor attribute to the second configuration is sent automatically by a processor.

12. The system of claim 8, wherein the first configuration and the second configuration associated with the sensor attribute are associated with at least one of a volume of data collected from the plurality of sensors, a frequency of data collected from the plurality of sensors, and a variation in types of data collected from the plurality of sensors.

13. The system of claim 8, wherein the first quality value and the second quality value are associated with an accuracy of classification.

14. The system of claim 8, wherein the first quality value and the second quality value are associated with anomalies in sensor data.

15. A computer program product comprising a computer readable storage medium having program instructions embodied therewith, the program instructions executable by a processor to cause the processor to perform operations, the operations comprising:
receiving a first set of sensor data from a plurality of sensors, the plurality of sensors having a sensor attribute associated with a first configuration;
determining, utilizing an artificial intelligence model, a first classification, wherein the first classification is determined based on the first set of sensor data from the plurality of sensors;
receiving a second set of sensor data from the plurality of sensors, the second set of sensor data having a second configuration associated with the sensor attribute;
determining a second classification; and
determining whether a difference between a first quality value associated with the first classification and a second quality value associated with the second classification exceeds a threshold.

16. The computer program product of claim 15, wherein determining whether a difference between a first quality value associated with the first classification and a second quality value associated with the second classification exceeds a threshold, includes:
identifying that the difference between a first quality value associated with the first classification and a second quality value associated with the second classification exceeds a threshold; and
sending a command to the plurality of sensors to set the sensor attribute to the first configuration.

17. The computer program product of claim 15, wherein determining whether a difference between a first quality value associated with the first classification and a second quality value associated with the second classification exceeds a threshold includes:
identifying that the difference between a first quality value associated with the first classification and a second quality value associated with the second classification does not exceed a threshold;
sending a command to the plurality of sensors to set the first data attribute to a third configuration;
receiving a third set of sensor data from the plurality of sensors, the plurality of sensors having the sensor attribute having a third configuration;
determining a third classification, utilizing the artificial intelligence model, utilizing the third set of sensor data;
identifying that a difference between the first quality value associated with the first classification and a third quality value associated with the third classification exceeds the threshold; and
sending a command to the plurality of sensors to set the sensor attribute to the second configuration.

18. The computer program product of claim 15, wherein the command to the plurality of sensors to set the sensor attribute to the second configuration is sent automatically by a processor.

19. The computer program product of claim 15, wherein the first configuration and the second configuration associated with the sensor attribute are associated with at least one of a volume of data collected from the plurality of sensors, a frequency of data collected from the plurality of sensors, and a variation in types of data collected from the plurality of sensors.

20. The computer program product of claim 15, wherein the first quality value and the second quality value are associated with an accuracy of classification.
